(19) United States
(12) Patent Application Publication
(10) Pub. No.: US 2016/0243526 A1
(43) Pub. Date: Aug. 25, 2016

(54) METHOD FOR PRODUCTION OF A CHROMATOGRAPHY MATERIAL

(71) Applicant: GE HEALTHCARE BIOPROCESS R&D AB, Uppsala (SE)

(72) Inventor: Tobias E. Soderman, Uppsala (SE)

(73) Assignee: GE Healthcare Bio-Sciences AB, Uppsala (SE)

(21) Appl. No.: 15/027,146

(22) PCT Filed: Oct. 9, 2014
(86) PCT No.: PCT/SE2014/051194

§ 371 Date: Apr. 4, 2016

(30) Foreign Application Priority Data
Oct. 10, 2013 (SE) 1351198-5

(51) Int. Cl. B01J 20/32; C08F 290/10; B01D 15/32; B01J 20/287

(52) U.S. Cl. CPC B01J 20/3278; B01J 20/287; C08F 290/10; B01D 15/325

(57) ABSTRACT

The present invention relates to a method for production of a chromatography material. More closely, the invention relates to a method for production of a reverse phase chromatography (RPC) material comprising the following steps: introduction of unsaturated groups onto porous carbohydrate particles and grafting of styrenic monomers on said particles comprising an unsaturated group.

### FIELD OF THE INVENTION

The present invention relates to a method for production of a chromatography material. More closely, the invention relates to a method for production of a reverse phase chromatography (RPC) material by surface modification of chromatography particles.

### BACKGROUND OF THE INVENTION

Adsorption chromatography depends on the chemical interactions between solute molecules and specifically designed ligands chemically grafted to a chromatography matrix. Over the years, many different types of ligands have been immobilised to chromatography supports for biomolecule purification, exploiting a variety of biochemical properties ranging from electronic charge to biological affinity. An important addition to the range of adsorption techniques for preparative chromatography of biomolecules has been reversed phase chromatography in which the binding of mobile phase solute to an immobilized n-alkyl hydrocarbon or aromatic ligand occurs via hydrophobic interaction. Reversed phase chromatography has found both analytical and preparative applications in the area of biochemical separation and purification. Molecules that possess some degree of hydrophobic character, such as proteins, peptides and nucleic acids, can be separated by reversed phase chromatography with excellent recovery and resolution. In addition, the use of ion pairing modifiers in the mobile phase allows reversed phase chromatography of charged solutes such as fully deprotected oligonucleotides and hydrophilic peptides. Preparative reversed phase chromatography has found applications ranging from micropurification of protein fragments for sequencing to process scale purification of recombinant protein products.

The separation mechanism in reversed phase chromatography depends on the hydrophobic binding interaction between the solute molecule in the mobile phase and the immobilised hydrophobic ligand, i.e. the stationary phase. The actual nature of the hydrophobic binding interaction itself is a matter of heated debate but the conventional wisdom assumes the binding interaction to be the result of a favourable entropy effect. The initial mobile phase binding conditions used in reversed phase chromatography are primarily aqueous which indicates a high degree of organised water structure surrounding both the solute molecule and the immobilised ligand. As solute binds to the immobilised hydrophobic ligand, the hydrophobic area exposed to the solvent is minimised. Therefore, the degree of organised water structure is diminished with a corresponding favourable increase in system entropy. In this way, it is advantageous from an energy point of view for the hydrophobic moieties, i.e. solute and ligand, to associate.

Reversed phase chromatography is an adsorptive process by experimental design, which relies on a partitioning mechanism to effect separation. The solute molecules partition (i.e. an equilibrium is established) between the mobile phase and the stationary phase. The distribution of the solute between the two phases depends on the binding properties of the medium, the hydrophobicity of the solute and the composition of the mobile phase. Initially, experimental conditions are designed to favour adsorption of the solute from the mobile phase to the stationary phase. Subsequently, the mobile phase composition is modified to favour desorption of the solute from the stationary phase back into the mobile phase. In this case, adsorption is considered the extreme equilibrium state where the distribution of solute molecules is essentially 100% in the stationary phase. Conversely, desorption is an extreme equilibrium state where the solute is essentially 100% distributed in the mobile phase.

Reversed phase chromatography of biomolecules generally uses gradient elution instead of isocratic elution. While biomolecules strongly adsorb to the surface of a reversed phase matrix under aqueous conditions, they desorb from the matrix within a very narrow window of organic modifier concentration. Along with these high molecular weight biomolecules with their unique adsorption properties, the typical biological sample usually contains a broad mixture of biomolecules with a correspondingly diverse range of adsorption affinities. The only practical method for reversed phase separation of complex biological samples, therefore, is gradient elution.

In summary, separations in reversed phase chromatography depend on the reversible adsorption/desorption of solute molecules with varying degrees of hydrophobicity to a hydrophobic stationary phase.

The first step in the chromatographic process is to equilibrate the column packed with the reversed phase medium under suitable initial mobile phase conditions of pH, ionic strength and polarity (mobile phase hydrophobicity). The polarity of the mobile phase is controlled by adding organic modifiers such as acetonitrile. Ion-pairing agents, such as trifluoroacetic acid, may also be appropriate. The polarity of the initial mobile phase (usually referred to as mobile phase A) must be low enough to dissolve the partially hydrophobic solute yet high enough to ensure binding of the solute to the reversed phase chromatographic matrix. In the second step, the sample containing the solutes to be separated is applied. Ideally, the sample is dissolved in the same mobile phase used to equilibrate the chromatographic bed. The sample is applied to the column at a flow rate where optimum binding will occur. Once the sample is applied, the chromatographic bed is washed further with mobile phase A in order to remove any unbound and unwanted solute molecules.

Bound solutes are next desorbed from the reversed phase medium by adjusting the polarity of the mobile phase so that the bound solute molecules will sequentially desorb and elute from the column. In reversed phase chromatography this usually involves decreasing the polarity of the mobile phase by increasing the percentage of organic modifier in the mobile phase. This is accomplished by maintaining a high concentration of organic modifier in the final mobile phase (mobile phase B). Generally, the pH of the initial and final mobile phase solutions remains the same. The gradual decrease in mobile phase polarity (increasing mobile phase hydrophobicity) is achieved by an increasing linear gradient from 100% initial mobile phase A containing little or no organic modifier to 100% (or less) mobile phase B containing a higher concentration of organic modifier. The bound solutes desorb from the reversed phase medium according to their individual hydrophobicities.

The fourth step in the process involves removing substances not previously desorbed. This is generally accomplished by changing mobile phase B to near 100% organic modifier in order to ensure complete removal of all bound substances prior to re-using the column.

The fifth step is re-equilibration of the chromatographic medium from 100% mobile phase B back to the initial mobile phase conditions. Separation in reversed phase chromatography is due to the different binding properties of the solutes present in the sample as a result of the differences in their hydrophobic properties. The degree of solute molecule binding to the reversed phase medium can be controlled by manipulating the hydrophobic properties of the initial mobile phase. Although the hydrophobicity of a solute molecule is difficult to quantitate, the separation of solutes that vary only slightly in their hydrophobic properties is readily achieved. Because of its excellent resolving power, reversed phase chromatography is an indispensable technique for the high performance separation of complex biomolecules. Typically, a reversed phase separation is initially achieved using a broad range gradient from 100% mobile phase A to 100% mobile phase B. The amount of organic modifier in both the initial and final mobile phases can also vary greatly. However, routine percentages of organic modifier are 5% or less in mobile phase A and 95% or more in mobile phase B.

The technique of reversed phase chromatography allows great flexibility in separation conditions so that the researcher can choose to bind the solute of interest, allowing the contaminants to pass unretarded through the column, or to bind the contaminants, allowing the desired solute to pass freely. Generally, it is more appropriate to bind the solute of interest because the desorbed solute elutes from the chromatographic medium in a concentrated state. Additionally, since binding under the initial mobile phase conditions is complete, the starting concentration of desired solute in the sample solution is not critical allowing dilute samples to be applied to the column.

A reversed phase chromatography medium consists of hydrophobic ligands chemically grafted to a porous, insoluble beaded matrix. The matrix must be both chemically and mechanically stable. The base matrix for the commercially available reversed phase media is generally composed of silica or a synthetic organic polymer such as polystyrene.

When choosing buffer conditions for a reversed phase separation the pH is one of the parameters that will highly influence the separation profile. Moreover the stability of the target molecule must also be considered. Therefore there is a need for reversed phase chromatography media that can be used over a wide pH range such as pH 3-12 to give the user maximal freedom in choosing the most optimal pH.

Although RPC media made of silica and polystyrene function satisfactory in many cases they are not possible to use over a wide pH-range. Previously, grafting of styrene on a polymeric (e.g. crosslinked polystyrene) support with a resulting change in pore structure has been shown to give some improvement in insulin separation, see U.S. Pat. No. 7,048,858 B2. Polystyrene is chemically stable over a wide pH range but suffers from inferior selectivity compared to silica at many pH values.

Silica on the other hand is not stable during prolonged use at pH above ˜8.

Thus there is still a need of improved RPC media that displays good selectivity over a wide pH range.

### SUMMARY OF THE INVENTION

The present invention provides a method for production of a RPC material based on porous carbohydrate particles that tolerates the demands on mechanical strength and gives a high selectivity within a wide pH-range.

Thus in a first aspect, the invention provides a method for production of reverse phase chromatography (RPC) material, comprising the following steps: introduction of unsaturated groups onto porous carbohydrate particles and grafting of styrenic monomers on said particles comprising an unsaturated group.

The porous carbohydrate particles are preferably made of polysaccharide material, most preferably agarose.

Agarose has previously successfully been used for Hydrophobic Interaction Cromatography (HIC) and many commercial products such as Butyl Sepharose Fast Flow (GE Healthcare) are available. Products for HIC should only be mildly hydrophobic and agarose has not been considered for reversed phase chromatography where a highly hydrophobic support is needed due to its inherent hydrophilicity and difficulty to make sufficiently hydrophobic.

The inventor has surprisingly found that by grafting of styrene on a crosslinked agarose particle, a sufficient hydrophobicity has been found in combination with good selectivity over the entire pH range which neither silica or polystyrene supports display.

Preferably the unsaturated groups are allyl groups in the production method.

In one embodiment of the method the allylation is performed with allylglycidylether (AGE).

The styrenic monomers may be selected from e.g. styrene, tert butyl styrene or pentafluorostyrene.

The styrenic monomer in the grafting solution v/v is preferably present in an amount from 5 to 95% (v/v) preferably from 25 to 75%.

In a preferred embodiment the allylation is with AGE and the styrenic monomer is styrene or tert butyl styrene present in 50% v/v in the grafting solution.

In a second aspect, the invention relates to a RPC material produced according to the above method.

In a third aspect, the invention relates to use of the above produced RPC material to perform reverse phase chromatography.

### BRIEF DESCRIPTION OF THE DRAWINGS

FIG. 1 shows a chromatogram of the separation of four test peptides (see Table 3 below) on the RPC prototype LS002597 (see Table 6 below) at pH 7.

FIG. 2 shows a chromatogram of the separation of four test peptides (see Table 3 below) on the RPC prototype LS002597 (see Table 6 below) at pH 3.

FIG. 3 shows a chromatogram of the separation of the four test peptides (see Table 3 below) on the RPC prototype LS002597 (see Table 6 below) at pH12.

FIG. 4 shows a chromatogram of the separation of four test peptides (see Table 3 below) on the RPC prototype LS002980 (see Table 6 below) at pH 7.

FIG. 5 shows a chromatogram of the separation of four test peptides (see Table 3 below) on the RPC prototype LS002980 (see Table 6 below) at pH 3.

FIG. 6 shows a chromatogram of the separation of four test peptides (see Table 3 below) on the RPC prototype LS002980 (see Table 6 below) at pH 12.

FIG. 7 shows a chromatogram of the separation of four test peptides (see Table 3 below) on the RPC prototype LS002889 (see Table 6 below) at pH 7.

FIG. 8 shows a chromatogram of the separation of four test peptides (see Table 3 below) on the RPC prototype LS002889 (see Table 6 below) at pH 3.

FIG. 9 shows a chromatogram of the separation of four test peptides (see Table 3 below) on the RPC prototype LS002889 (see Table 6 below) at pH 12.

FIG. 10 shows a chromatogram of the separation of four test peptides (see Table 3 below) on the RPC prototype LS003147A (see Table 6 below) at pH 7.

FIG. 11 shows a chromatogram of the separation of four test peptides (see Table 3 below) on the RPC prototype LS003147A (see Table 6 below) at pH 3.

FIG. 12 shows a chromatogram of the separation of four test peptides (see Table 3 below) on the RPC prototype LS003147A (see Table 6 below) at pH 12.

FIG. 13 shows a chromatogram of a comparative study of the same four test peptides (Table 3) on a silica column (prior art) at pH 7.

FIG. 14 shows a chromatogram of a comparative study of the same four test peptides (Table 3) on a silica column (prior art) at pH 3.

FIG. 15 shows a chromatogram of a comparative study of the same four test peptides (Table 3) on a polystyrene column (prior art) at pH 7.

FIG. 16 shows a chromatogram of a comparative study of the same four test peptides (Table 3) on a polystyrene column (prior art) at pH 3.

FIG. 17 shows a chromatogram of a comparative study of the same four test peptides (Table 3) on a polystyrene column (prior art) at pH 12.

### DETAILED DESCRIPTION OF THE INVENTION

The invention will now be described more closely in relation to some non-limiting examples and the accompanying drawings.

### EXPERIMENTAL SECTION

### Materials

A porous crosslinked agarose particle of 8.35 μm in average particle size has been used for all experiments.

The coupling reagents are listed in Table 1.

TABLE 1
Coupling Reagents

| | | Supplier article |
|---|---|---|
| Chemical | Supplier | number |
| Allyl glycidyl ether | Sigma-Aldrich | A32608 |
| Sodium hydroxide | Merck Millipore | 106467 |
| Sodium borohydride | Sigma-Aldrich | 71320 |
| 2,2-Azobis(2- | Fluka | 11596 |
| methylbutyronitril) | | |
| (AMBN) | | |
| Styrene | Sigma-Aldrich | S4972 |
| Tert-butylstyrene | Sigma-Aldrich | 523933 |
| 2,3,4,5,6- | Sigma-Aldrich | 196916 |
| Pentafluorstyrene | | |

### Experiment 1

### LS002597 Allylation and Grafting of Polystyrene onto Agarose Particles

### Allylation

50 mL of agarose particles were washed on a sintered glass filter with 500 mL of distilled water. A 50% (w/w) solution of sodium hydroxide in distilled water was prepared and the particles were washed with 300 mL of the 50% sodium hydroxide solution. The particles were sucked dry and transferred to a 250 mL round-bottom flask equipped with a mechanical stirrer. 40 mL of 50% sodium hydroxide was added and the temperature was increased to 50° C. The stirring rate was set at 250 rpm. When the temperature is stable, 50 mL of allyl glycidyl ether was added. The reaction was allowed to proceed overnight.

The particle suspension was transferred to a sintered glass filter and the particles were washed with 500 mL of distilled water, 500 mL of ethanol and 500 mL of 20% ethanol.

The amount of attached allyl groups was determined with a titration method and was found to be 625 μmol/mL of particles.

### Grafting of Poly(Styrene)

10 mL of allylated agarose particles as prepared above were washed on a sintered glass filter with 100 mL of toluene. The particles were sucked dry and were transferred to a 50 mL falcon tube. 15 mL of toluene, 15 mL of styrene and 270 mg of AMBN (the toluene and styrene constitutes the grafting solution) were added. Nitrogen gas was flushed through the particle suspension for 5 minutes. The falcon tube was sealed with a cap and placed in a heated shaking table set at 70° C. The reaction was allowed to proceed for 18 h.

The particle suspension was transferred to a sintered glass filter and the particles were washed with 300 mL of toluene, 300 mL of ethanol and 100 mL of 20% ethanol.

### Experiment 2

### LS002980 Grafting of Allylated Agarose Particles with Polystyrene (Increased Amount of Styrene)

10 mL of allylated agarose particles as prepared in experiment 1 were washed on a sintered glass filter with 100 mL of toluene. The particles were sucked dry and were transferred to a 50 mL falcon tube. 10 mL of toluene, 20 mL of styrene and 360 mg of AMBN were added. Nitrogen gas was flushed through the particle suspension for 5 minutes. The falcon tube was sealed with a cap and placed in a heated shaking table set at 70° C. The reaction was allowed to proceed for 18 h.

The particle suspension was transferred to a sintered glass filter and the particles were washed with 300 mL of toluene, 300 mL of ethanol and 100 mL of 20% ethanol.

### Experiment 3

### LS002597 Allylation and Grafting of Poly(Pentafluorostyrene) onto Agarose Particles

### Allylation

200 mL of agarose particles were washed on a sintered glass filter with 2000 mL of distilled water. A 50% (w/w) solution of sodium hydroxide in distilled water was prepared and the particles were washed with 1200 mL of the 50% sodium hydroxide solution. The particles were sucked dry and transferred to a 1000 mL round-bottom flask equipped with a mechanical stirrer. 160 mL of 50% sodium hydroxide and 1.2 g of sodium borohydride were added and the temperature was increased to 50° C. The stirring rate was set at 600 rpm. When the temperature is stable, 200 mL of allyl glycidyl ether was added. The reaction was allowed to proceed overnight.

The particle suspension was transferred to a sintered glass filter and the particles were washed with 500 mL of distilled water, 500 mL of ethanol and 500 mL of 20% ethanol.

The amount of attached allyl groups was determined with a titration method and was found to be 501 μmol/mL of particles.

### Grafting of Poly(Pentafluorostyrene)

10 mL of allylated agarose particles were washed on a sintered glass filter with 100 mL of toluene. The particles were sucked dry and are transferred to a 50 mL falcon tube. 15 mL of toluene, 15 mL of pentafluorostyrene and 270 mg of AMBN were added. Nitrogen gas was flushed through the particle suspension for 5 minutes. The falcon tube was sealed with a cap and placed in a heated shaking table set at 70° C. The reaction was allowed to proceed for 18 h.

The particle suspension was transferred to a sintered glass filter and the particles were washed with 300 mL of acetone, 300 mL of ethanol and 100 mL of 20% ethanol.

### Experiment 4

### LS003147A, Allylation and Grafting of Poly(Tert-Butylstyrene) onto Agarose Particles

### Allylation

200 mL of agarose particles were allylated as in Experiment 3. The amount of attached allyl groups was determined with a titration method and was found to be 501 μmol/mL of particles.

### Grafting of Poly(Tert-Butyl Styrene)

10 mL of allylated agarose particles were washed on a sintered glass filter with 100 mL of toluene. The particles were sucked dry and were transferred to a 50 mL falcon tube. 15 mL of toluene, 15 mL of tert-butyl styrene and 270 mg of AMBN were added. Nitrogen gas was flushed through the particle suspension for 5 minutes. The falcon tube was sealed with a cap and placed in a heated shaking table set at 70° C. The reaction is allowed to proceed for 18 h.

The particle suspension was transferred to a sintered glass filter and the particles were washed with 300 mL of atoluene, 300 mL of ethanol and 100 mL of 20% ethanol.

### Experiment 5

### Peptide Separation on Prototypes and Reference Products

Four peptides at different pH values were used as test peptides for the chromatographic evaluation method. Some properties of the peptides are listed in Table.

TABLE 2
Peptide properties

| Substance | Amino acid sequence | pI |
|---|---|---|
| Angiotensin I | Asp-Arg-Val-Tyr-Ile-His-Pro- | ~9 |
| | Phe-His-Leu | |
| Ile7-Angiotensin | Arg-Val-Tyr-Ile-His-Pro-Ile | ~7 |
| III | | |
| Val4-Angiotensin | Arg-Val-Tyr-Val-His-Pro-Phe | ~7 |
| III | | |
| Angiotensin III | Arg-Val-Tyr-Ile-His-Pro-Phe | ~7 |

### Prototypes and Columns

The RPC prototype materials according to the invention, see Experiments 1-4, were packed into Tricorn 5/50 columns (GE Healthcare Bio-Sciences AB) 0.98 mL column colume. Also, for comparative purposes SOURCE 15 RPC (GE Healthcare Bio-Sciences AB) and Kromasil 100-13-C4 (Akzo Nobel) were packed into Tricorn 5/50 columns An ÄKTA (TM?) Explorer 10S system (GE Healthcare Bio-Sciences AB) was used to run the separation method

The materials used in the separation method are listed in Table 3.

TABLE 3
Peptides and other chemicals used in the separation method

| | | Supplier |
|---|---|---|
| Substance | Supplier | article number |
| Angiotensin I | Sigma-Aldrich | A9650 |
| Ile7-Angiotensin III | Sigma-Aldrich | A0911 |
| Val4-Angiotensin III | Sigma-Aldrich | A6277 |
| Angiotensin III | Sigma-Aldrich | 10385 |
| Sodium dihydrogen phosphate | Merck Millipore | 1.06346.1000 |
| monohydrate | | |
| Ortho-Phosphoric acid, 85% | Merck | 1.00573.2500 |
| Disodium hydrogen phosphate, | Merck Millipore | 1.06586.0500 |
| anhydrous | | |
| Acetonitrile | Merck Millipore | 1.00030.2500 |

### Buffer Preparation

15 mM Sodium phosphate pH 3.0 buffer:

0.176 mL of phosphoric acid and 1.71 g sodium dihydrogen phosphate monohydrate were dissolved to a final volume of 1 L in Milli Q water.

15 mM Sodium phosphate pH 7.0 buffer:

1.032 g of Sodium dihydrogen phosphate monohydrate and 1.068 g of disodium hydrogen phosphate were dissolved to a final volume of 1 L.

10 mM Sodium hydroxide is used as pH 12 solution. The solution was prepared using a Titrisol ampoule that was diluted with Milli-Q water to 1 L final volume.

### Peptide Separation Method.

The test peptides: Angiotensin I, Ile7-Angiotensin III, Val4-Angiotensin III and Angiotensin III were dissolved in Milli-Q water to a final concentration of 0.125 mg/mL for each peptide.

The separation is carried out at pH 3.0 and pH 7.0 and 12.0.

A buffer is 15 mM sodium phosphate pH 3.0 or pH 7.0 or 10 mM NaOH pH 12. B buffer is acetonitrile.

An overview of the method is given below:

| Block | Info | length |
|---|---|---|
| Equilibration | 0.5 mL/min, 3.5% B | 5 CV |
| | | (1 CV = 0.98 mL) |
| Sample injection | 10 μL | N.A. |
| Wash after | 0.5 mL/min | 2 CV |
| injection | | |
| Gradient step 1 | 3.5-100% B, 0.5 mL/min | 21.4 CV |
| Gradient step 2 | 100% B | 7 CV |
| Gradient step 3 | 0% B, 0 CV, 0.5 mL/min | 3 CV |
| CIP | 1M NaOH in 20% EtOH, 0.5 | 5 CV |
| | mL/min | |
| Storage solution | 20% EtOH, 0.5 mL/min | 5 CV |

UV 215 nm is used as the detection wavelength.

Depending on the pH the peptides will be positively charged (pH 3), nearly uncharged (pH 7) or negatively charged (pH 12). The charge of the peptides may affect the separation. If for instance negatively charged groups are present on the particles this could lead to peak broadening at low pH since the then positively charged peptides will be retained by both ionic and hydrophobic interactions.

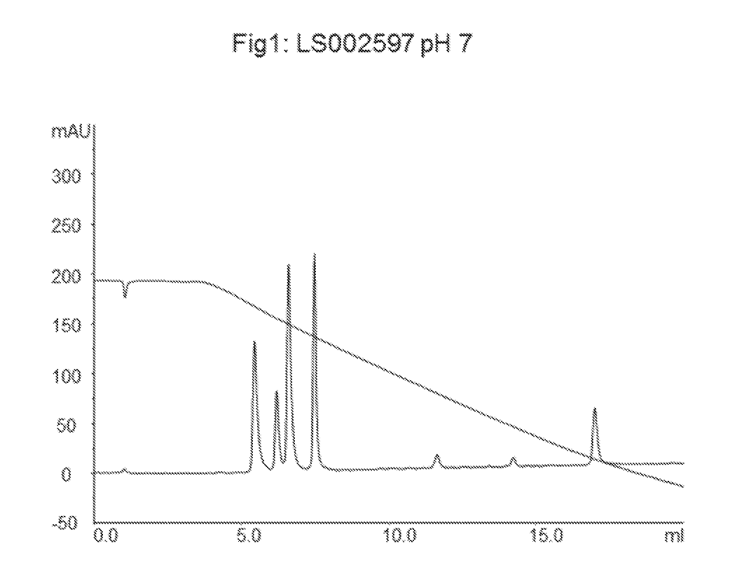

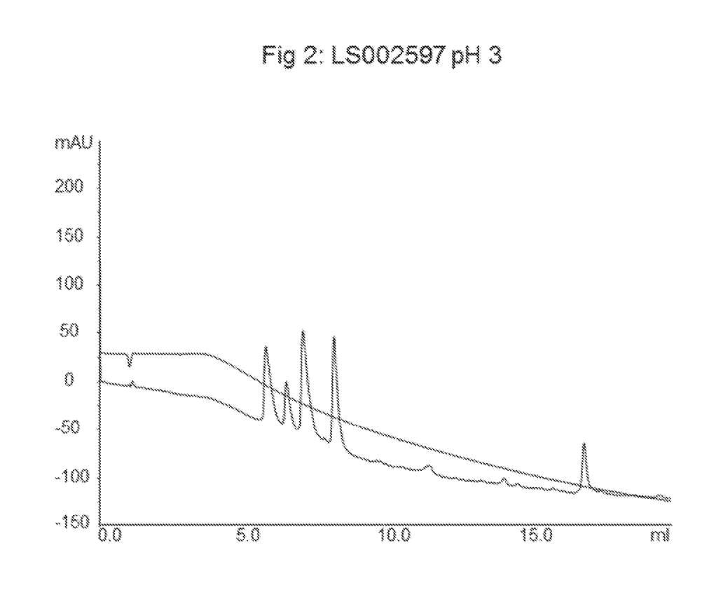

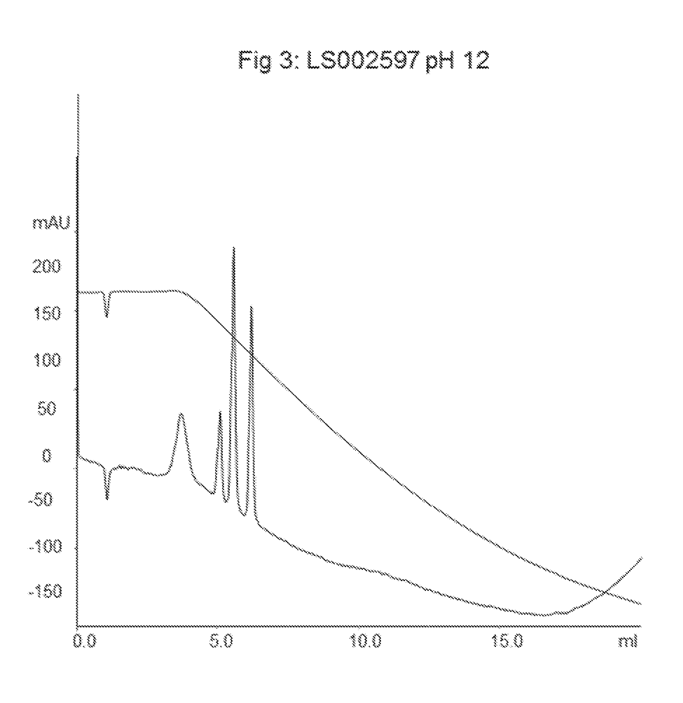

FIGS. 1-3 show chromatograms of the separation of the prototype LS002597 at pH 7, pH 3 and pH 12, respectively.

LS002597 has a very good overall performance with sharp peaks at all pH values. One of the peptides does not bind at pH 12 where the peptides are strongly negatively charged.

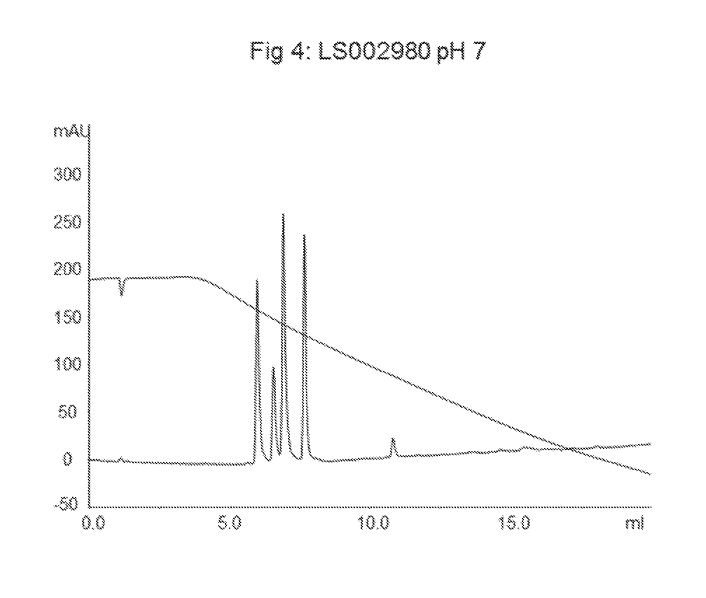

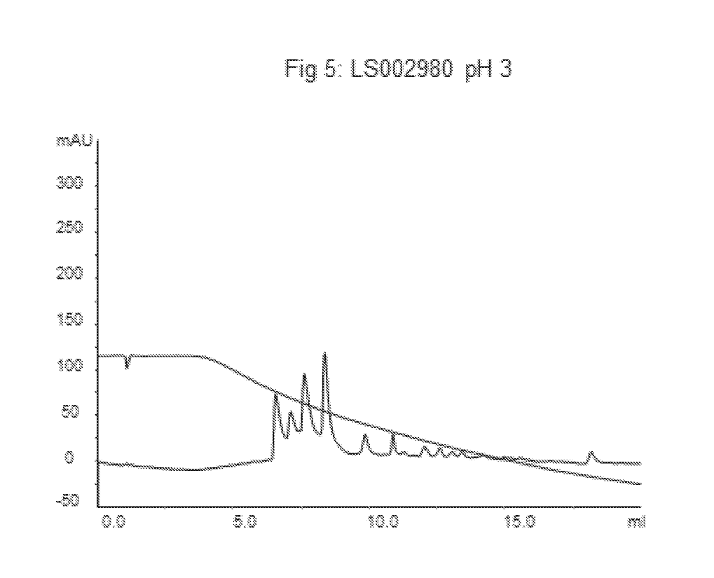

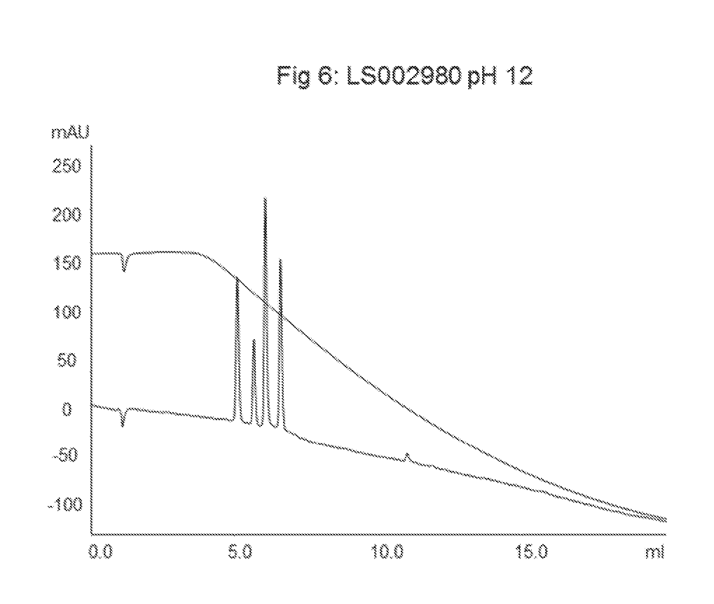

FIGS. 4-6 show chromatograms of the separation of the prototype LS002980 at pH 7, pH 3 and pH 12, respectively. LS002980 has very good overall performance and is one of the few prototypes that have sufficient hydrophobicity to retain all four peptides at pH 12, where an excellent separation is obtained. The separation at pH 3 gives slightly broader peaks than e.g. LS002597 but the separation at pH 7 is highly comparable to Kromasil C4 100 Å.

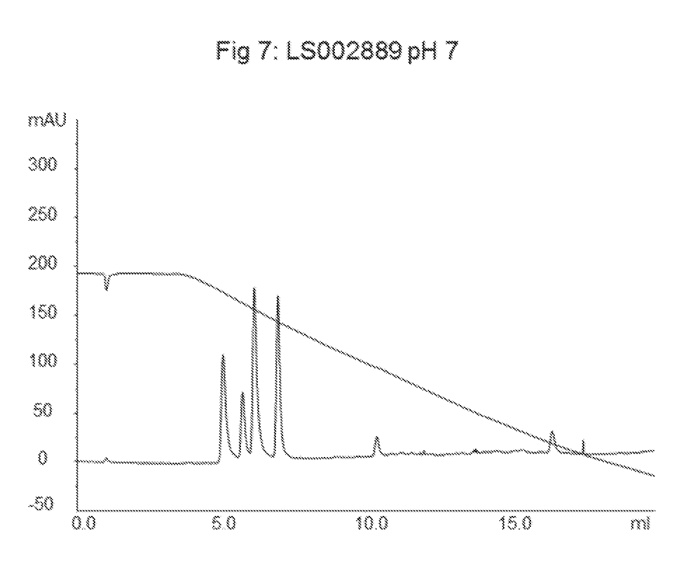

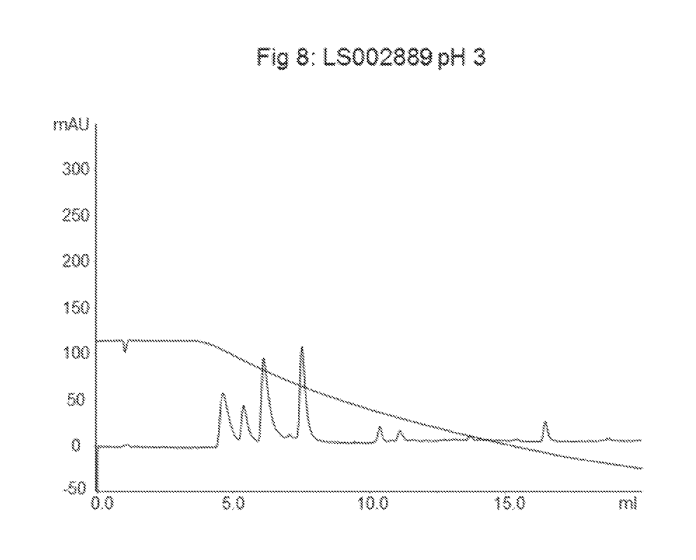

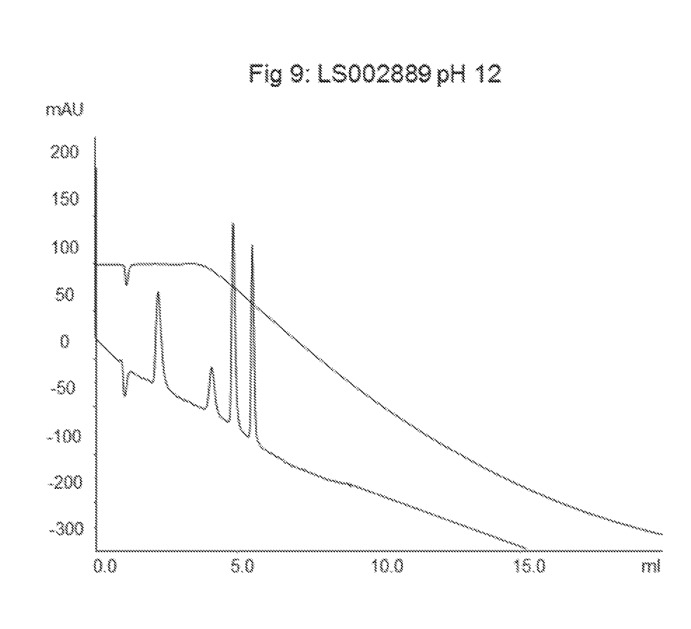

FIGS. 7-9 show chromatograms of the separation of the prototype LS002889 at pH 7, pH 3 and pH 12, respectively.

The prototype grafted with poly(pentaflurostyrene) (LS002889) gives good separation at all pH values, the separation pattern is similar to LS 002597.

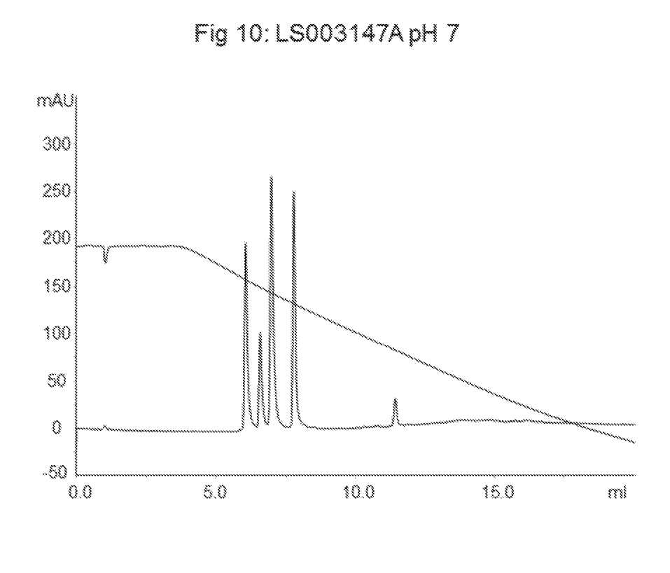

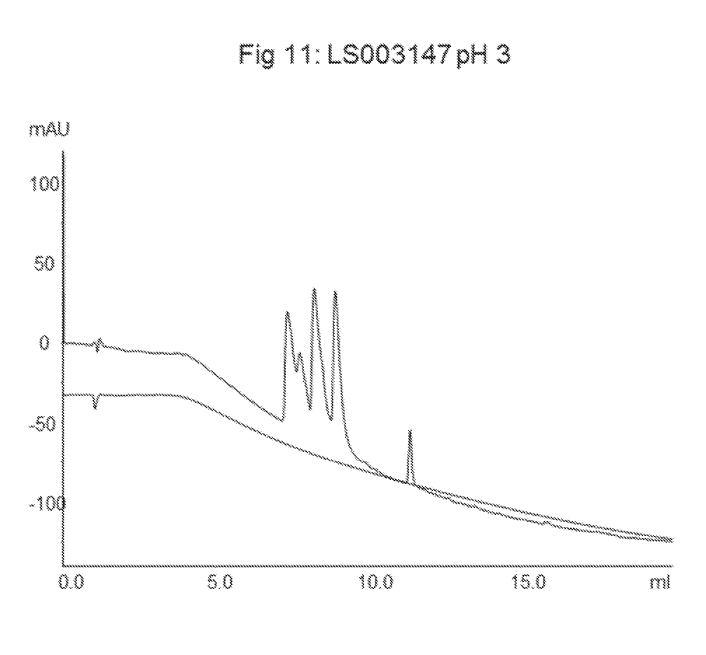

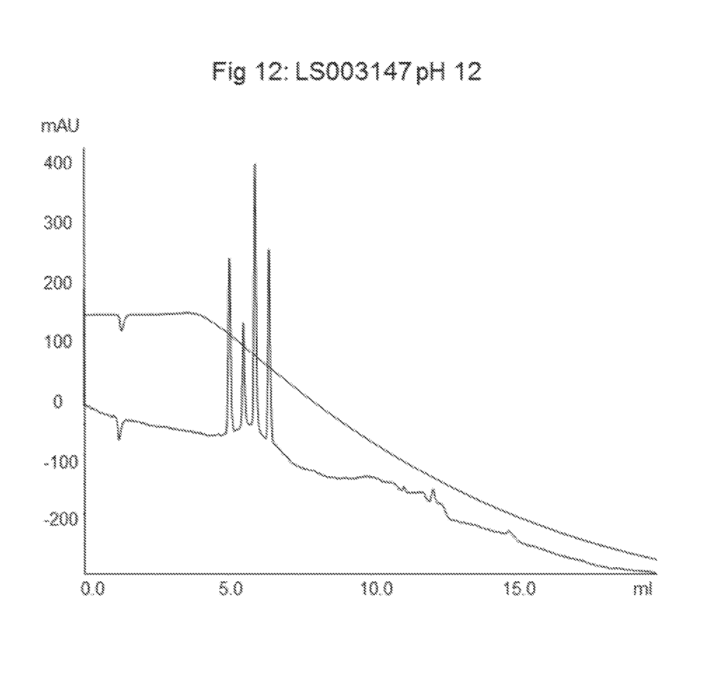

FIGS. 10-12 show chromatograms of the separation of the prototype LS003147A at pH 7, pH 3 and pH 12, respectively. Tertbutylstyrene (LS003147A) gives very good performance overall.

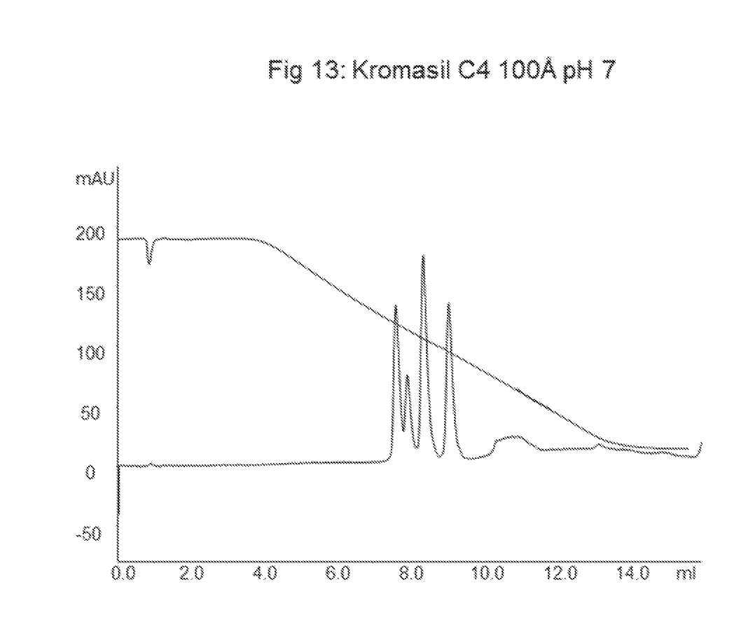

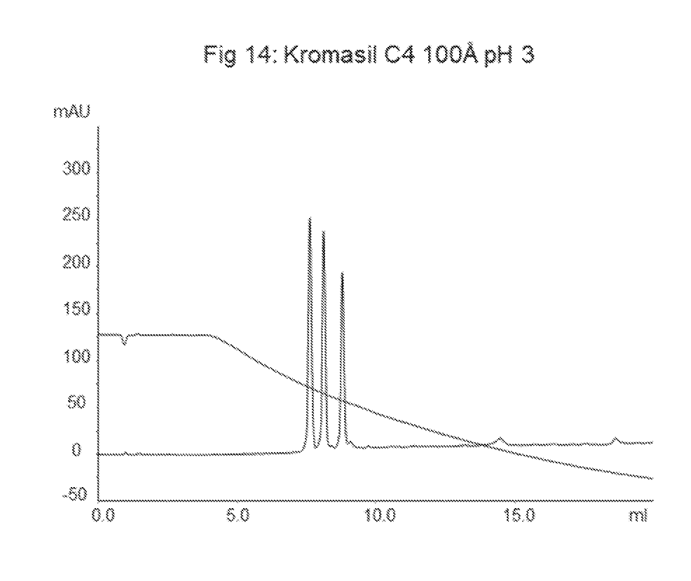

FIGS. 13-14 are comparative figures showing chromatograms of Kromasil C4 100 Å. at pH 7, and pH 3 respectively.

The Kromasil column gives good separation at pH 7 but cannot separate the peptides at pH 3, only three peaks are observed. The retention times for all peptides are much longer than for the agarose-based prototypes. This means that more organic solvents must be used to elute the peptides in this case. The separation at pH 12 was not run for the Kromasil column since silica-based products products are not stable above pH ˜8.

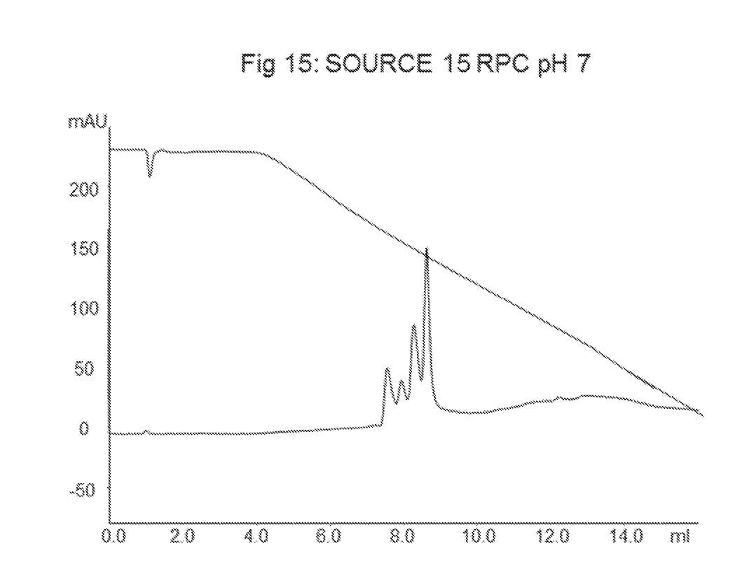

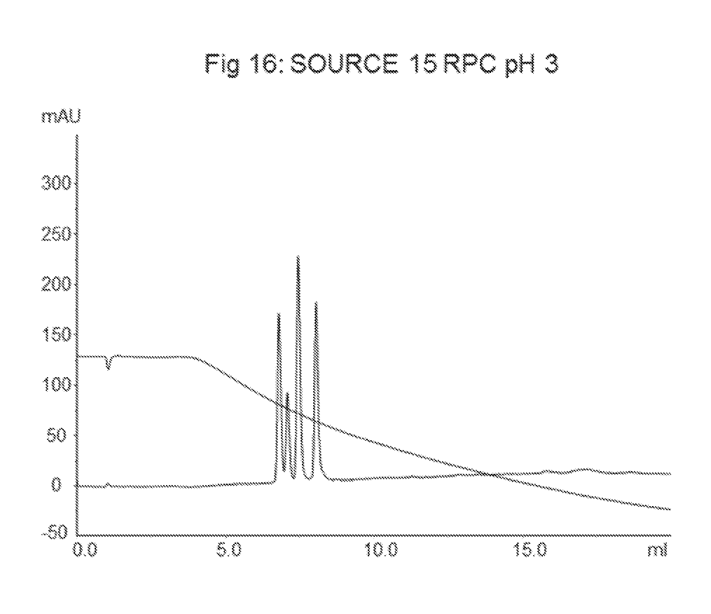

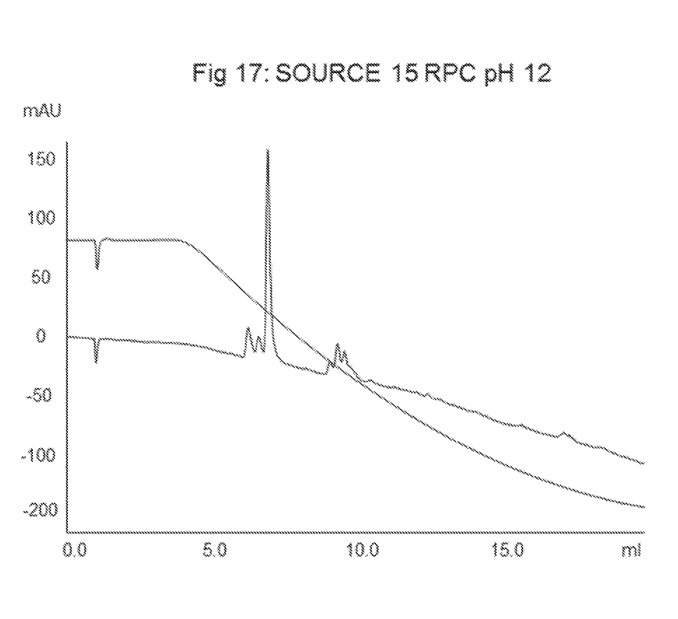

FIGS. 15-17 are comparative figures showing chromatograms of Source 15 RPC at pH 7, pH 3 and pH 12 respectively. The SOURCE 15 RPC column displays a good separation at pH3 but gives a poor separation and broad peaks at both pH 7 and 12.

1. A method for production of reverse phase chromatography (RPC) material, comprising the following steps: introduction of unsaturated groups onto porous carbohydrate particles and grafting of styrenic monomers on said particles comprising an unsaturated group.

2. Method according to claim 1, wherein the porous carbohydrate particles are made of polysaccharide material.

3. Method according to claim 1, wherein the porous carbohydrate particles are made of agarose.

4. Method according to claim 1, wherein the unsaturated groups are allyl groups.

5. Method according to claim 4, wherein the allylation is performed with allylglycidylether (AGE).

6. Method according to claim 1, wherein the styrenic monomers are selected from styrene, tert butyl styrene or pentafluorostyrene.

7. Method according to claim 1, wherein the styrenic monomer I the grafting solution v/v is from 5 to 95% (v/v) preferably from 25 to 75%.

8. Method according to claim 1, wherein the allylation is with AGE and the styrenic monomer is styrene or tert butyl styrene present in 50% v/v in the grafting solution.

9. A RPC material produced according to claim 1.

10. RPC material produced according to claim 8.

11. Use of the RPC material in claim 10 to perform reverse phase chromatography.
